(19) United States
(12) Patent Application Publication
(10) Pub. No.: US 2020/0071512 A1
(43) Pub. Date: Mar. 5, 2020

(54) WATER-BASED COMPOSITION HAVING IMPROVED MECHANICAL PROPERTIES

(71) Applicant: SIKA TECHNOLOGY AG, Baar (CH)

(72) Inventors: André BUCHHOLZ, Ritterhude (DE); Steffen MAIER, Wettingen (CH); Urs JÄGER, Jona (CH)

(73) Assignee: SIKA TECHNOLOGY AG, Baar (CH)

(21) Appl. No.: 16/493,684

(22) PCT Filed: Mar. 28, 2018
(86) PCT No.: PCT/EP2018/057947

§ 371 Date: Sep. 12, 2019

(30) Foreign Application Priority Data
Mar. 29, 2017 (EP) 17163572.5

(51) Int. Cl. C08L 33/08; C08L 31/04; C08L 75/04; C08G 18/10; C08G 18/28; C08K 3/013; C08K 3/22; C08K 3/26; C08K 5/544; C09D 5/08; C09D 133/08; C09J 133/08

(52) U.S. Cl. CPC C08L 33/08; C08K 2003/265; C08L 75/04; C08G 18/10; C08G 18/289; C08K 3/013; C08K 3/22; C08K 3/26; C08K 5/544; C09D 5/08; C09D 133/08; C09J 133/08; C08L 2201/54; C08L 2312/00; C08K 2003/2241; C08L 31/04

(57) ABSTRACT

A composition containing an aqueous polymer dispersion including water and at least one water-dispersible polymer and at least one silane-terminated polymer and to a method for protecting a substrate against stone-chipping and/or corrosion. Also relating to a method for sealing a joint between two substrates, to a method for coating a surface of substrate and to a method for adhesively bonding two substrates. Furthermore, the use of silane-terminated polymers in sealants, coatings, and adhesives containing aqueous dispersion of water-dispersible polymers for improving the mechanical properties of the sealants, coatings, and adhesives.

### TECHNICAL FIELD

The invention relates to water-based compositions used as sealants, coatings and adhesives. In particular, the invention relates to coatings, which are used for protecting metal parts of vehicles, such as busses, trucks and railway coaches, against stone-chipping, corrosion, and other ambient impacts.

### BACKGROUND OF THE INVENTION

Sealants, coatings and adhesives based on solvent- or water-based polymer dispersions are commonly used in the field of construction for sealing joints, for protecting surfaces against water penetration and other ambient influences and for elastic bonding of substrates. These products harden by drying, which results in increased physical interaction between the polymers contained in the dispersion. Compared to solvent-based formulations, the water-based compositions have the inherent advantage of low emission of volatile organic solvents, which are known to be hazardous to environment and health of workers. Furthermore, the water-based sealants, coatings and adhesives are generally of low odor and more suitable for indoor applications.

Moisture curing compositions have also been used as sealants, coatings and adhesives. These compositions are typically based on isocyate-functional polymers or silane-functional polymers and they have both been used for sealing, coating and elastic bonding of porous mineral substrates such as concrete and the like. From the environmental and toxicological standpoint the silane-based moisture curing compositions are preferred over compositions based on isocyanate functional polymers.

The preferred properties of the compositions used as sealants, coatings and adhesives depend strongly on the area of application. For elastic bonding and sealing, it is advantageous that the composition after drying has relatively low Shore A hardness as well as high flexibility and elastic recovery. In case of sealing constructions joints, a good bonding to porous mineral substrates such as concrete is essential. Sealants, coatings and adhesives based on solvent- or water-based polymer dispersions tend have the disadvantage of providing suboptimal adhesion after long term water-storage. Moisture curing compositions containing polymers with reactive functional groups provide good bonding even after long term water storage but the cured compositions have lower flexibility, which makes them less suitable for elastic sealing of joints.

Motor vehicles such as cars, busses, trucks and railway coaches and especially the underbody components of such vehicles are often exposed to extreme environments in terms of weather exposure, salt water exposure, fresh water exposure, heat from the sun, and the like during their service lives. Abrasion resistant coatings are frequently used for protecting the metal parts of vehicles against stone-chipping, corrosion, and other ambient impacts. These protective coatings find their use mainly in the underbody regions of a vehicle and in wheel arches and in so called skills. They are also used to seal off spot-welded or otherwise mechanically fastened seams against penetration of dust and water.

State-of-the-art underbody protective coatings include plastisols, which are dispersions of organic polymers in plasticizers. These undergo a curing reaction when heated to relatively high temperatures of 130-160° C. and harden on cooling. Typical organic polymers used in plastisols include (meth)acrylate homopolymers and copolymers, styrene copolymers and in particular, PVC homopolymers and/or copolymers. In addition to polymer dispersion, plastisols typically also contain high-boiling hydrocarbons as extenders. Although the plasticizers and extenders have a relatively low vapor pressure, a small part of these components is evaporated when the applied composition is heated to the required curing temperature. This leads to emission and condensation problems in the coating ovens of the automotive industry. Due to the high curing temperature the plastisols are less suitable for use for coating underbodies of large vehicles.

Underbody protective coatings based on polymer dispersions are also known and water-based systems are nowadays predominantly used due to the lower ecological impact. These polymer dispersions also contain low cost filler materials, which are used as reinforcing additives to improve the impact strength of the protective coating and to decrease the production costs. Underbody protective coatings based on aqueous polymer dispersions typically have a solids content of 65-75% and densities of up to 1.5 g/cm³. Commonly used coatings have to be applied with a thickness of up to 3 mm in order to ensure sufficient protection effect. However, due to the relatively high density of the coatings, the thickness of the applied coating can be limited by the maximum allowable axle weight of the vehicle.

Protective coatings based on aqueous polymer dispersions are subjected to certain requirements, which are related to their drying behavior and to the mechanical stability of the coatings at lower temperatures. The drying process should occur without unwanted blistering and formation of larger or smaller pores or unwanted expansion. The dried coating should not become brittle at temperatures below 0° C. and they should absorb only minor amounts of water upon contact with atmospheric moisture. The latter requirement is particularly challenging for water-based coating systems with polymers based on at least partially water-soluble monomers.

There is thus a need to develop a new composition, which can be used for providing an underbody protective coating for vehicles and for elastic sealing, coating and bonding in the field of construction industry.

### SUMMARY OF THE INVENTION

It is an objective of the present invention to provide a composition, which can be used as underbody protective coating of vehicles, which coating has excellent stone impact resistance even when applied in low coating weight.

Another objective of the present invention is to provide a method for protecting metal parts, in particular underbody parts of automotive vehicles against stone-chipping and corrosion.

Another objective of the present invention is to provide a method for sealing a joint between substrates.

Another objective of the present invention is to provide a method for coating a surface of a substrate.

Another objective of the present invention is to provide a method for adhesively bonding two substrates.

A still objective of the present invention is to provide a use of a composition for protective coating of substrates against stone-chipping and/or corrosion and/or for sealing a joint between two substrates and/or for coating a surface of a substrate and/or for adhesively bonding of two substrates.

A still another objective of the present invention is to provide a use of silane-functional polymers in sealants, coatings, and adhesives containing aqueous dispersions of water-dispersible polymers for improving the mechanical properties of the sealants, coatings, and adhesives

It was surprisingly found out that the objectives can be achieved with a composition comprising an aqueous dispersion of at least one water-dispersible polymer and at least one silane-terminated polymer.

It was also surprisingly found out that such a combination of aqueous polymer dispersion and at least one silane-terminated polymer can be formulated as a one-component storage stable composition. A person skilled in the art would expect the silane-terminated polymers to immediately react with the water contained in the aqueous polymer dispersion such that a one-component storage stable composition could not be formed.

The subject of the present invention is a composition as defined in claim 1.

One of the advantages of the composition of the present invention is that abrasion resistant protective coatings having high mechanical strength can be provided without the use of excessive amounts reinforcing fillers. Due to the low amount of fillers the density of the protective coating remains relatively low and the weight of the applied coating does not significantly increase the axle weight of the vehicle. Due to the high mechanical strength the coating can also be applied as a thin film, which enables a further reduction of the coating weight.

Another advantage of the composition of the present invention is that protective coatings, which are substantially free of plasticizers and volatile organic solvents, can be provided.

Another advantage of the present invention is that the composition is suitable for elastic sealing, coating and bonding, since the composition after curing is relatively flexible and has a good bonding and mechanical properties even after long term water storage.

Still another advantage of the composition of the present invention is that it provides good bonding with various materials such as concrete, glass, anodized aluminum, stainless steel, polymethyl methacrylate (PMMA), polycarbonate, PVC, ABS and wood.

Other aspects of the present invention are presented in other independent claims. Preferred aspects of the invention are presented in the dependent claims.

### DETAILED DESCRIPTION OF THE INVENTION

The subject of the present invention is a composition comprising:

a) an aqueous polymer dispersion of at least one water-dispersible polymer,

b) at least one silane-terminated polymer,

c) optionally at least one catalyst for the crosslinking of said silane-terminated polymers.

In this document, the term “one-component composition” or “one-part composition” refers to composition, which is contained in a single container, preferably a moisture-tight container, and which composition has certain storage stability.

The terms “storage stability” and “shelf life stability” refer to the ability of a composition to be stored at room temperature in a suitable container under exclusion of moisture for a certain time interval, in particular several months, without undergoing significant changes in application or end-use properties.

The prefix “poly” in substance designations such as “polyol” or “polyisocyanate” refers to substances which in formal terms contain two or more per molecule of the functional group that occurs in their designation. A polyol, for example, is a compound having two or more hydroxyl groups, and a polyisocyanate is a compound having two or more isocyanate groups.

The term “polymer” in the present document encompasses on the one hand a collective of chemically uniform macromolecules which nevertheless differ in respect of degree of polymerization, molar mass, and chain length, said collective having been prepared through a polymerization reaction (chain-growth addition polymerization, polyaddition, polycondensation). On the other hand the term also encompasses derivatives of such a collective of macromolecules from polymerization reactions, in other words compounds which have been obtained by reactions, such as additions or substitutions, for example, of functional groups on existing macromolecules and which may be chemically uniform or chemically nonuniform. The term “moreover” further embraces what are called prepolymers, these being reactive oligomeric preadducts whose functional groups have participated in the construction of macromolecules.

The term “polyurethane polymer” refers to polymers prepared by so called diisocyanate polyaddition process. This also includes those polymers which are virtually free or entirely free from urethane groups. Examples of polyurethane polymers are polyether-polyurethanes, polyester-polyurethanes, polyether-polyureas, polyureas, polyester-polyureas, polyisocyanurates, and polycarbodiimides.

The term “dispersion” refers to a physical state of matter that includes at least two distinct phases, wherein a first phase is distributed in a second phase, with the second phase being a continuous medium. Preferably, the dispersion comprises a solid phase which is dispersed as solid particles in a continuous liquid phase.

The term “aqueous polymer dispersion” refers to a dispersion containing solid polymer particles emulsified or suspended in water as the main continuous (carrier) phase. Preferably, the “aqueous” refers to a 100% water carrier.

In this document, the term “water-dispersible” when used in the context of a polymer (or a prepolymer) means that (1) the polymer is itself capable of being dispersed into an aqueous carrier, in particular water (e.g., without requiring the use of a separate surfactant) or (2) an aqueous carrier can be added to the polymer to form a stable dispersion (i.e., the dispersion should have at least one month shelf stability at normal storage temperatures).

The term “(meth)acrylic” refers to methacrylic or acrylic. Accordingly, the term “(meth)acrylate” refers to methacrylate or acrylate.

The terms “silane” and “organosilane” respectively identify compounds which in the first instance have at least one, customarily two or three, hydrolyzable groups bonded directly to the silicon atom via Si—O— bonds, more particularly alkoxy groups or acyloxy groups, and in the second instance have at least one organic radical bonded directly to the silicon atom via an Si—C bond. Silanes with alkoxy or acyloxy groups are also known to the person skilled in the art as organoalkoxysilanes and organoacyloxysilanes, respectively. “Tetraalkoxysilanes”, consequently, are not organosilanes under this definition.

Correspondingly, the term “silane group” refers to the silicon-containing group bonded to the organic carbon radical via the Si—C bond. The silanes, and their silane groups, have the property of undergoing hydrolysis on contact with moisture. In so doing, they form organosilanols, these being organosilicon compounds containing one or more silanol groups (Si—OH groups) and, by subsequent condensation reactions, organosiloxanes, these being organosilicon compounds containing one or more siloxane groups (Si—O—Si groups).

The term “silane-functional” refers to compounds which have silane groups. “Silane-functional polymers” accordingly, are polymers which have at least one silane group. The term “silane-terminated polymer” refers to polymers having silane-groups at their chain ends.

Silane designations with functional groups as prefixes such as “aminosilanes” or “mercaptosilanes”, for example, identify silanes which carry the stated functional group on the organic radical as a substituent.

The terms “organotitanate”, “organozirconate”, and “organoaluminate” in the present document identify compounds which have at least one ligand bonding via an oxygen atom to the titanium, zirconium, and aluminum atom, respectively.

A “multidentate ligand” or “chelate ligand” in the present document is a ligand which possesses at least two free electron pairs and is able to occupy at least two coordination sites on the central atom. A bidentate ligand, accordingly, is able to occupy two coordination sites on a central atom.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The number average molecular weight can be determined by gel permeation chromatography (GPC) with a polystyrene standard.

In this document, an amine or an isocyanate is called “aliphatic” when its amine group or its isocyanate group, respectively, is directly bound to an aliphatic, cycloaliphatic or arylaliphatic moiety. The corresponding functional group is therefore called an aliphatic amine or an aliphatic isocyanate group, respectively.

In this document, an amine or an isocyanate is called “aromatic” when its amine group or its isocyanate group, respectively, is directly bound to an aromatic moiety. The corresponding functional group is therefore called an aromatic amine or an aromatic isocyanate group, respectively.

The term “primary amine group” refers to an NH₂-group bound to an organic moiety, and the term “secondary amine group” refers to a NH-group bound to two organic moieties which together may be part of a ring.

In this document, the term “room temperature” refers to a temperature of ca. 23° C.

A dashed line in the chemical formulas of this document represents the bonding between a moiety and the corresponding rest of the molecule.

Preferably, the composition is a one-component composition, in particular a one-component water-based composition. The term “water-based refers in the present document to compositions in which the solvent for the composition comprises more than 50% by weight of water, based on the total weight of the solvent. In certain embodiments, the solvent for the composition comprises more than 75% by weight of water, such as more than 85% by weight of water, such as more than 95% by weight of water, or more than 99% by weight water, based on the total weight of the solvent.

The composition of the present invention comprises at least one water-dispersible polymer. Suitable water-dispersible polymers are homopolymers, copolymers and higher inter-polymers prepared by free-radical addition polymerization of ethylenically unsaturated monomers. The term “higher-interpolymer” refers in the present document to polymers containing three or more different monomers.

The amount of the at least one water-dispersible polymer in the composition is not subjected to any particular restrictions. Preferably, the at least one water-dispersible polymer is present in the composition in a total amount of 1-50% by weight, preferably 5-45% by weight, more preferably 10-35% by weight, most preferably 15-30% by weight, based on the total weight of the composition.

Preferably, the water content of the composition is 1.0-35.0% by weight, preferably 2.5-30.0% by weight, more preferably 5.0-30.0% by weight, most preferably 7.5-25.0% by weight, based on the total weight of the composition.

Preferably, the amount of the aqueous polymer dispersion is 5-70% by weight, more preferably 10-60% by weight, even more preferably 15.0-50% by weight, most preferably 20-40% by weight, based on the total weight of the composition.

Preferably, the aqueous polymer dispersion has a solids content of 20-90% by weight, preferably 30-85% by weight, more preferably 40-75% by weight, most preferably 45-70% by weight.

The “solids content” refers in the present document to the portion of the composition, which when heated to a temperature of 105° C. for one hour at one atmosphere pressure does not volatilize. Accordingly, the solids content refers to polymeric materials, non-volatile plasticizers, inorganic solids and non-volatile organic materials, whereas the non-solid portion is generally comprised of water and any organic materials readily volatilized at 105° C.

Preferably, the composition has a solids content before drying of 40-90% by weight, preferably 50-85% by weight, most preferably 55-80% by weight.

Suitable water-dispersible polymers contain as principal monomers ethylenically unsaturated monomers selected from the group consisting of C₁-C₂₀-alkyl (meth)acrylates, vinyl esters of carboxylic acids containing up to 20 carbon atoms, vinyl aromatic compounds containing up to 20 carbon atoms, ethylenically unsaturated nitriles, vinyl halides, and non-aromatic hydrocarbons having at least two conjugated double bonds. The term “principal monomer” refers in the present document to monomers, which make up more than 50% by weight of the total weight of the polymer.

Suitable C₁-C₂₀-alkyl (meth)acrylates include, for example, (meth)acrylic acid alkyl esters having a C₁-C₁₂ alkyl radical, such as methyl (meth)acrylate, ethyl acrylate, 2-, n-butyl acrylate, n-hexyl acrylate, octyl acrylate, 2-ethylhexyl acrylate, 2-propylheptyl acrylate, isodecyl methacrylate. In particular, mixtures of (meth)acrylic acid alkyl esters are also preferable.

Suitable vinyl esters of carboxylic acids containing up to 20 carbon atoms include, for example, vinyl laurate, vinyl stearate, vinyl propionate, vinyl esters of tertiary saturated monocarboxylic acids, vinyl acetate, and mixtures of two or more thereof.

Suitable vinyl aromatic compounds include, for example, vinyltoluene, α- and p-methylstyrene, α-butylstyrene, 4-n-butylstyrene, 4-n-decylstyrene and styrene.

Suitable nitrile compounds include, for example, acrylonitrile and methacrylonitrile.

Suitable vinyl halides include, for example ethylenically unsaturated compounds substituted by chlorine, fluorine or bromine, such as vinyl chloride or vinylidene chloride, and mixtures thereof.

For the preparation of suitable water-dispersible polymers there are furthermore suitable non-aromatic hydrocarbons containing from 2 to 8 carbon atoms and at least two olefinic double bonds, such as butadiene, isoprene and chloroprene.

Suitable water-dispersible polymers may contain further monomers, for example, C₁-C₁₀-hydroxyalkyl (meth)acrylates, (meth)acrylamides and derivatives thereof substituted on the nitrogen by C₁-C₄-alkyl, ethylenically unsaturated carboxylic acids, dicarboxylic acids, their semi-esters and anhydrides, for example (meth)acrylic acid, maleic acid, fumaric acid, maleic acid anhydride, maleic acid and fumaric acid semi-esters and itaconic acid. These further monomers may be present in the water-dispersible polymer in an amount of not more than 50% by weight, preferably 0-40% by weight, more preferably from 0-20% by weight.

Particularly suitable water-dispersible polymers include, for example, polyvinyl acetate (PVA); polyvinyl alcohol (PVOH); poly(meth)acrylates; (meth)acrylate-styrene copolymers, (meth)acrylate vinyl-acetate copolymers; copolymers of (meth)acrylates and vinyl esters of tertiary carboxylic acids; copolymers of (meth)acrylates, vinyl esters of tertiary carboxylic acids and vinyl-acetate; styrene-butadiene copolymers, carboxylated styrene-butadiene copolymers, styrene-isoprene copolymers; polyurethanes; polyurethane-acrylates; ethylene-vinyl acetate copolymers (EVA); copolymers of ethylene, vinyl-acetate and vinyl ester;

ethylene-(meth)acrylate copolymers; ethylene-ethyl acrylate copolymers; ethylene-butyl acrylate copolymers; ethylene-(meth)acrylic acid copolymers; ethylene-2-ethylhexyl acrylate copolymers; and polyolefin block-copolymers. The above-mentioned copolymers can be block-type copolymers or random copolymers. The water-dispersible polymers can also be functionalized, meaning they can contain further functional groups such as hydroxyl-, carboxyl, anhydride-, acrylate-, glycidylmethacrylate-, and/or silane-groups.

Suitable silane-functionalized water-dispersible polymers can be obtained, for example, by using silane-group containing comonomers in the preparation of the polymers. In particular, suitable silane-functionalized water-dispersible polymers can be obtained by using (meth)acrylate alkoxysilane or vinylalkoxysilane comonomers in the preparation of water-dispersible polymers. Suitable (meth)acrylate alkoxysilanes and vinylialkoxysilanes are commercially available, for example, as MEMO® VTEO®, VTMO®, and VTMOEO® (from Evonik Industries).

The water-dispersible polymers can be prepared by free-radical addition polymerization using substance, solution, suspension or emulsion polymerization techniques, which are known to the person skilled in the art. Preferably, the polymer is obtained by solution polymerization with subsequent dispersion in water or, especially, by emulsion polymerization, so that aqueous polymer dispersions are obtained.

Suitable water-dispersible polymers have average molecular weight (Mn) in the range of 5,000-200,000 g/mol, preferably 25,000-200,000 g/mol, most preferably 50,000-200,000 g/mol.

Preferably, the aqueous polymer dispersion comprises at least one water-dispersible polymer selected from the group consisting of styrene-(meth)acrylate copolymers; styrene-butadiene copolymers; (meth)acrylate-vinyl acetate copolymers; copolymers of (meth)acrylates and vinyl esters of tertiary carboxylic acids; copolymers of (meth)acrylates, vinyl esters of tertiary carboxylic acids, and vinyl acetate; ethylene-acrylic acid copolymer; poly(meth)acrylates; ethylene-vinyl acetate copolymers; copolymers of vinyl acetate, ethylene, and vinyl ester; and polyurethanes.

It may be advantageous that the aqueous polymer dispersion comprises a mixture of water-dispersible polymers selected from the group consisting of styrene-(meth)acrylate copolymers; styrene-butadiene copolymers; (meth)acrylate-vinyl acetate copolymers; copolymers of (meth)acrylates and vinyl esters of tertiary carboxylic acids; copolymers of (meth)acrylates, vinyl esters of tertiary carboxylic acids, and vinyl acetate; ethylene-acrylic acid copolymer; poly(meth)acrylates; ethylene-vinyl acetate copolymers; copolymers of vinyl acetate, ethylene, and vinyl ester; and polyurethanes.

According to one or more embodiments, the at least one water-dispersible polymer has a glass transition temperature (T_{g}) of 5-100° C., preferably 5-75° C., more preferably 10-50° C., most preferably 15-45° C. Water-dispersible polymers having a glass transition temperature (T_{g}) in the above cited ranges are suitable for forming films having high strength and wear resistance, which is essential in protective coating applications.

The term “glass transition temperature” refers to the temperature measured by differential scanning calorimetry (DSC) according to ISO 11357 standard above which temperature a polymer component becomes soft and pliable, and below which it becomes hard and glassy. The measurements can be performed with a Mettler Toledo 822e device at a heating rate of 2° C./min. The T_{g} values can be determined from the measured DSC curve with the help of the DSC software.

According to one or more embodiments, the at least one water-dispersible polymer has a glass transition temperature (T_{g}) of <50° C., preferably <25° C., more preferably <10° C., most preferably <0° C. Water-dispersible polymers having a glass transition temperature (T_{g}) in the above cited ranges are suitable for forming films having high flexibility, which is essential when the composition is used for providing sealant and adhesives.

According to one or more embodiments, the aqueous polymer dispersion comprises at least one water-dispersible polymer selected from the group consisting of styrene-(meth)acrylate copolymers; styrene-butadiene copolymers; and (meth)acrylate-vinyl acetate copolymers. Aqueous polymer dispersions comprising one or more of the listed water-dispersible polymers have been found out to be particularly suitable for providing compositions used as protective coatings.

According to one or more preferred embodiments, the aqueous polymer dispersion comprises at least one water-dispersible polymer having a glass transition temperature (T_{g}) of 5-100° C., preferably 5-75° C., more preferably 10-50° C., most preferably 15-45° C., wherein the at least one water-dispersible polymer is selected from the group consisting of styrene-(meth)acrylate copolymers; styrene-butadiene copolymers; and (meth)acrylate-vinyl acetate copolymers.

According to one or more embodiments, the aqueous polymer dispersion comprises at least one water-dispersible polymer selected from the group consisting of C₁-C₂₀-alkyl-(meth)acrylate copolymers; styrene-(meth)acrylate copolymers; copolymers of vinyl esters of tertiary carboxylic acids; ethylene-vinyl acetate copolymers; and polyurethanes. Aqueous polymer dispersions comprising one or more of the listed water-dispersible polymers have been found out to be particularly suitable for providing compositions used as sealants and adhesives.

According to one or more preferred embodiments, the aqueous polymer dispersion comprises at least one water-dispersible polymer having a glass transition temperature (T_{g}) of <50° C., preferably <25° C., more preferably <10° C., most preferably <0° C., wherein the at least one water-dispersible polymer selected from the group consisting of C₁-C₂₀-alkyl (meth)acrylate copolymers; styrene-(meth)acrylate copolymers; copolymers of vinyl esters of tertiary carboxylic acids; ethylene-vinyl acetate copolymers; and polyurethanes.

According to one or more embodiments, the aqueous polymer dispersion comprises at least one acrylic polymer. The term “acrylic polymer” refers in the present document to homopolymers, copolymers and higher inter-polymers of an acrylic monomer with one or more further acrylic monomers and/or with one or more other ethylenically unsaturated monomers. The term “acrylic monomer” refers in the present document to esters of (meth)acrylic acid, (meth)acrylic acid or derivatives thereof, for example, amides of (meth)acrylic acid or nitriles of (meth)acrylic acid. Preferably, the acrylic polymer contains at least 30% by weight, more preferably at least 40% by weight of acrylic monomers.

Particularly suitable acrylic polymers consist for the most part of (meth)acrylates of alcohols containing from 1 to 24 carbon atoms ((meth)acrylic acid ester monomers). There are preferably more than 25% by weight of these basic monomer building blocks in the acrylic polymer. Further monomer building blocks include, for example, vinyl esters and allyl esters of carboxylic acids containing from 1 to 20 carbon atoms, vinyl ethers of alcohols containing from 1 to 8 carbon atoms, vinyl aromatic compounds, in particular styrene, vinyl halides, non-aromatic hydrocarbons containing from 2 to 8 carbon atoms and at least one olefinic double bond, α and β-unsaturated mono- or di-carboxylic acids containing from 3 to 6 carbon atoms, and derivatives thereof (especially amides, esters and salts). Monomers containing silane-groups can also be present in the acrylic polymers.

Preferably, the acrylic polymer has a number average molecular weight (Mn) in the range of 5,000-200,000 g/mol, preferably 25,000-200,000 g/mol, most preferably 50,000-200,000 g/mol and/or a weight average molecular weight (Mw) in the range of 50,000-800,000 g/mol, preferably 100,000-800,000 g/mol, most preferably 150,000-800,000 g/mol.

Suitable acrylic polymer dispersions and preparation method thereof are described, for example in EP 0490191 A2, DE 19801892 A1, and in EP 0620243.

Suitable commercially available aqueous acrylic polymer dispersions include Arconal® A200, Arconal® A323, Arconal® A378, Arconal® 380, Arconal® 5036, Arconal® 5041, Arconal® 6767, Arconal® S 410, Arconal® S 559, Arconal® 5047, Acronal® V275, Acronal® V278 (from BASF), Airflex® EAF 60, and Airflex® EAF 67 (from APP), Mowilith® DM 1340 (from Clariant), Primal® CA 162, and Primal® CA 172 (from Rohm and Haas).

The aqueous polymer dispersion can comprise two or more different acrylic polymers having different glass transition temperatures and different monomer compositions. Aqueous polymer dispersions comprising two or more different acrylic polymers can be prepared by mixing commercially available acrylic polymer dispersions, such as those described above.

According to one or more embodiments, the aqueous polymer dispersion comprises at least one acrylic polymer and at least one water-dispersible polymer selected from the group consisting of styrene-butadiene copolymers; vinyl esters of tertiary carboxylic acids, and vinyl acetate; ethylene-vinyl acetate copolymers; and polyurethanes.

The comprises at least one silane-terminated polymer, which has preferably one, two or more groups, in particular end groups, of the formula (I):

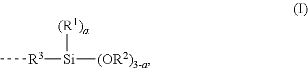

wherein

radical R¹ is an alkyl group having 1 to 8 C atoms, more particularly a methyl group or an ethyl group,

radical R² is an acyl or alkyl group having 1 to 5 C atoms, more particularly a methyl group or an ethyl group or an isopropyl group, most preferably R² is an ethyl group,

radical R³ is a linear or branched, optionally cyclic, alkylene group having 1 to 12 C atoms, optionally with aromatic moieties, and optionally with 1 or more heteroatoms, more particularly with one or more nitrogen atoms, and

a has a value of 0 or 1 or 2, preferably 0.

Within a silane group of the formula (I), R¹ and R², each independently of one another, are the radicals as described. Thus, for example, possible compounds of the formula (I) include those which represent the ethoxy-dimethoxy-alkylsilanes (R²=methyl, R²=methyl, R²=ethyl).

Preferably, the silane-terminated polymer is a silane-terminated polyurethane polymer. In particular, the silane-terminated polymer is preferably a silane-terminated polyurethane polymer that is entirely free of isocyanate groups.

It has been found out that increasing the amount of silane-terminated polymers in the composition improves mechanical properties of the sealants, coatings and adhesives. In particular, the stone-chipping resistance of a protective coating and flexibility of sealants is improved by increasing the amount of silane-terminated polymers. Also the water uptake of the hardened/cured compositions has been found out to decrease with higher amounts of silane-terminated polymers.

On the other hand, increasing the amount of silane-terminated polymers over a certain limit has also been found out to have a negative impact on the storage-stability of the compositions. In order to ensure storage stability, the total amount of silane-terminated polymers is preferable not more than 20.0% by weight, more preferably not more than 15.0% by weight, most preferably not more than 12.5% by weight, based on the total weight of the composition.

According to one or more embodiments, the at least one silane-terminated polymer is present in the composition in a total amount of 0.05-15.0% by weight, preferably 0.1-12.5% by weight, more preferably 0.5-12.5% by weight, most preferably 0.75-10.0% by weight, based on the total weight of the composition.

According to one or more embodiments, the at least one silane-terminated polymer is present in the composition in a total amount of 0.05-5.0% by weight, preferably 0.1-4.5% by weight, more preferably 0.5-4.0% by weight, most preferably 0.75-3.5% by weight, based on the total weight of the composition.

According to one or more embodiments, the silane-terminated polymer is a silane-terminated polyurethane polymer P1, which is obtainable by the reaction of a silane having at least one group that is reactive toward isocyanate groups, with a polyurethane polymer which contains isocyanate groups. This reaction is carried out preferably in a stoichiometric ratio of the groups that are reactive toward isocyanate groups to the isocyanate groups of 1:1, or with a slight excess of groups that are reactive toward isocyanate groups, meaning that the resulting silane-terminated polyurethane polymer is preferably entirely free of isocyanate groups.

The silane which has at least one group that is reactive toward isocyanate groups is, for example, a mercaptosilane, an aminosilane or a hydroxysilane, more particularly an aminosilane. The aminosilane is preferably an aminosilane of the formula (Ia):

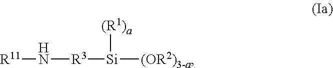

wherein the radicals R¹, R², R³, and a have the already described meanings and R¹¹ is a hydrogen atom or is a linear or branched hydrocarbon radical having 1 to 20 C atoms that optionally contains cyclic moieties, or is a radical of the formula (II):

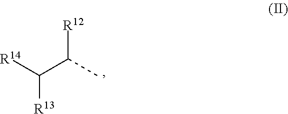

wherein the radicals R¹² and R¹³, independently of one another, are a hydrogen atom or a radical from the group encompassing —R¹⁵, —CN, and —COOR¹⁵, radical R¹⁴ is a hydrogen atom or is a radical from the group encompassing —CH₂—COOR¹⁵, —COOR¹⁵, CONHR¹⁵, —CON(R¹⁵)₂, —CN, —NO₂, —PO(OR¹⁵)₂, —SO₂R¹⁵, and —SO₂OR¹⁵, and the radical R¹⁵ is a hydrocarbon radical having 1 to 20 C atoms that optionally comprises at least one heteroatom.

Examples of suitable aminosilanes include primary aminosilanes such as 3-aminopropyltriethoxysilane, 3-aminopropyldiethoxymethylsilane; secondary aminosilanes such as N-butyl-3-aminopropyltriethoxysilane, N-phenyl-3-aminopropyltriethoxysilane; the products of the Michael-like addition of primary aminosilanes such as 3-aminopropyltriethoxysilane or 3-amino-propyldiethoxymethylsilane onto Michael acceptors such as acrylonitrile, (meth)acrylic esters, (meth)acrylamides, maleic diesters and fumaric diesters, citraconic diesters and itaconic diesters, examples being dimethyl and diethyl N-(3-triethoxysilylpropyl)aminosuccinate; and also analogs of the stated aminosilanes having methoxy or isopropoxy groups instead of the preferred ethoxy groups on the silicon. Particularly suitable aminosilanes are secondary aminosilanes, more particularly aminosilanes in which R⁴ in formula (III) is different from H. Preferred are the Michael-like adducts, more particularly diethyl N-(3-triethoxysilylpropyl)aminosuccinate.

The term “Michael acceptor” refers in the present document to compounds which on the basis of the double bonds they contain, activated by electron acceptor radicals, are capable of entering into nucleophilic addition reactions with primary amino groups (NH₂ groups) in a manner analogous to Michael addition (hetero-Michael addition).

Examples of suitable polyurethane polymers containing isocyanate groups for the preparation of a silane-terminated polyurethane polymer include polymers which are obtainable by the reaction of at least one polyol with at least one polyisocyanate, more particularly a diisocyanate. This reaction may take place by the polyol and the polyisocyanate being reacted by customary methods, as for example at temperatures of 50° C. to 100° C., optionally with accompanying use of suitable catalysts, the polyisocyanate being metered such that its isocyanate groups are present in a stoichiometric excess in relation to the hydroxyl groups of the polyol.

More particularly the excess of polyisocyanate is preferably selected such that in the resulting polyurethane polymer, after the reaction of all hydroxyl groups of the polyol, the remaining free isocyanate group content is from 0.1 to 5 wt.-%, preferably 0.1 to 2.5 wt.-%, more preferably 0.2 to 1 wt.-%, based on the overall polymer.

The polyurethane polymer may optionally be prepared with accompanying use of plasticizers, in which case the plasticizers used contain no groups that are reactive toward isocyanates.

Preferred polyurethane polymers with the stated amount of free isocyanate groups are those obtained from the reaction of diisocyanates with high molecular mass diols in an NCO:OH ratio of 1.5:1 to 2:1.

Suitable polyols for preparing the polyurethane polymer are, in particular, polyether polyols, polyester polyols, and polycarbonate polyols, and also mixtures of these polyols.

Especially suitable polyether polyols, also called polyoxyalkylene polyols or oligoetherols, are those which are polymerization products of ethylene oxide, 1,2-propylene oxide, 1,2- or 2,3-butylene oxide, oxetane, tetrahydrofuran, or mixtures thereof, optionally polymerized with the aid of a starter molecule having two or more active hydrogen atoms, such as water, ammonia, for example, or compounds having two or more OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the stated compounds. Use may be made both of polyoxyalkylene polyols which have a low degree of unsaturation (measured by ASTM D-2849-69 and expressed in milliequivalents of unsaturation per gram of polyol (meq/g)), prepared for example by means of double metal cyanide complex catalysts (DMC catalysts), and of polyoxyalkylene polyols having a higher degree of unsaturation, prepared for example by means of anionic catalysts such as NaOH, KOH, CsOH, or alkali metal alkoxides.

Particularly suitable are polyoxyethylene polyols and polyoxypropylene polyols, more particularly polyoxyethylene diols, polyoxypropylene diols, polyoxyethylene triols, and polyoxypropylene triols.

Especially suitable are polyoxyalkylene diols or polyoxyalkylene triols having a degree of unsaturation of less than 0.02 meq/g and having an average molecular weight in the range from 1,000 to 30,000 g/mol, and also polyoxyethylene diols, polyoxyethylene triols, polyoxypropylene diols, and polyoxypropylene triols having an average molecular weight of 400 to 20,000 g/mol. Likewise particularly suitable are so-called ethylene oxide-terminated (“EO-endcapped”, ethylene oxide-endcapped) polyoxypropylene polyols. The latter are special polyoxypropylene-polyoxyethylene polyols which are obtained, for example, by subjecting pure polyoxypropylene polyols, more particularly polyoxypropylene diols and triols, to further alkoxylation with ethylene oxide after the end of the polypropoxylation reaction, and which therefore have primary hydroxyl groups. Preferred in this case are polyoxypropylene-polyoxyethylene diols and polyoxypropylene-polyoxyethylene triols.

Additionally suitable are hydroxyl group terminated polybutadiene polyols, examples being those prepared by polymerization of 1,3-butadiene and allyl alcohol or by oxidation of polybutadiene, and their hydrogenation products.

Additionally suitable are styrene-acrylonitrile grafted polyether polyols, of the kind available commercially, for example, under the trade name Lupranol® from BASF Polyurethanes GmbH, Germany.

Especially suitable as polyester polyols are polyesters which carry at least two hydroxyl groups and are prepared by known processes, particularly by the polycondensation of hydroxycarboxylic acids or the polycondensation of aliphatic and/or aromatic polycarboxylic acids with dihydric or polyhydric alcohols.

Especially suitable polyester polyols are those prepared from di- to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or mixtures of the aforesaid alcohols, with organic dicarboxylic acids or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid, and trimellitic anhydride, or mixtures of the aforesaid acids, and also polyester polyols of lactones such as E-caprolactone, for example.

Particularly suitable are polyester diols, especially those prepared from adipic acid, azelaic acid, sebacic acid, dodecanedicarboxylic acid, dimer fatty acid, phthalic acid, isophthalic acid, and terephthalic acid as dicarboxylic acid, or from lactones such as E-caprolactone, for example, and from ethylene glycol, diethylene glycol, neopentyl glycol, 1,4-butanediol, 1,6-hexanediol, dimer fatty acid diol, and 1,4-cyclohexanedimethanol as dihydric alcohol.

Especially suitable polycarbonate polyols are those obtainable by reaction, for example, of the abovementioned alcohols, used for synthesis of the polyester polyols, with dialkyl carbonates such as dimethyl carbonate, diaryl carbonates such as diphenyl carbonate, or phosgene. Particularly suitable are polycarbonate diols, especially amorphous polycarbonate diols.

Other suitable polyols are poly(meth)acrylate polyols.

Likewise suitable, moreover, are polyhydrocarbon polyols, also called oligohydrocarbonols, examples being polyhydroxy-functional ethylene-propylene, ethylene-butylene or ethylene-propylene-diene copolymers, as produced for example by Kraton Polymers, USA, or polyhydroxy-functional copolymers of dienes such as 1,3-butanediene or diene mixtures and vinyl monomers such as styrene, acrylonitrile or isobutylene, or polyhydroxy-functional polybutadiene polyols, examples being those which are prepared by copolymerization of 1,3-butadiene and allyl alcohol and which may also have been hydrogenated.

Additionally suitable are polyhydroxy-functional acrylonitrile/butadiene copolymers of the kind preparable, for example, from epoxides or amino alcohols and carboxyl-terminated acrylonitrile/butadiene copolymers, which are available commercially under the name Hypro® (formerly Hycar®CTBN from Emerald Performance Materials, LLC, USA.

These stated polyols preferably have a molecular weight of 250 to 30,000 g/mol, more particularly of 1,000 to 30,000 g/mol, and an average OH functionality in the range from 1.6 to 3.

Particularly suitable polyols are polyester polyols and polyether polyols, more particularly polyoxyethylene polyol, polyoxypropylene polyol, and polyoxypropylene-polyoxyethylene polyol, preferably polyoxyethylene diol, polyoxypropylene diol, polyoxyethylene triol, polyoxypropylene triol, polyoxypropylene-polyoxyethylene diol, and polyoxypropylene-polyoxyethylene triol.

Further to these stated polyols it is possible as well to use small amounts of low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher alcohols, low molecular weight alkoxylation products of the aforesaid dihydric and polyhydric alcohols, and also mixtures of the aforesaid alcohols, when preparing the polyurethane polymer having terminal isocyanate groups.

As polyisocyanates for the preparation of the polyurethane polymer it is possible to use commercially customary aliphatic, cycloaliphatic or aromatic polyisocyanates, more particularly diisocyanates. Suitable diisocyanates by way of example are those whose isocyanate groups are bonded in each case to one aliphatic, cycloaliphatic or arylaliphatic C atom, also called “aliphatic diisocyanates”, such as 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, lysine diisocyanate and lysine ester diisocyanate, cyclohexane 1,3-diisocyanate, cyclohexane 1,4-diisocyanate, 1-isocyanato-3,3,5-trimethyl-5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis(1-isocyanato-1-methylethyl)naphthalene; and also diisocyanates having isocyanate groups bonded in each case to one aromatic C atom, also called “aromatic diisocyanates”, such as 2,4- and 2,6-tolylene diisocyanate (TDI), 4,4′-, 2,4′-, and 2,2′-diphenylmethane diisocyanate (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI); oligomers and polymers of the aforementioned isocyanates, and also any desired mixtures of the aforementioned isocyanates.

Suitable methoxysilane-funtional polymers are available commercially, for example, under the trade name Polymer ST50 from Hanse Chemie AG, Germany, and also under the trade name Desmoseal® from Covestro. Preferably, the silane-terminated polymer P1 is an ethoxysilane-terminated polyurethane polymer.

According to one or more preferred embodiments, the silane-terminated polymer is a silane-terminated polyurethane polymer P2, which is obtainable through the reaction of isocyanotosilane with a polymer which has functional end groups that are reactive toward isocyanates, these end groups being more particularly hydroxyl groups, mercapto groups and/or amino groups. This reaction takes place in a stoichiometric ratio of the isocyanate groups to the functional end groups that are reactive toward isocyanate groups of 1:1, or with a slight excess of the functional end groups that are reactive toward isocyanate groups, at temperatures, for example, of 20° C. to 100° C., optionally with accompanying use of catalysts.

Suitable isocyanatosilanes include compounds of the formula (Ib):

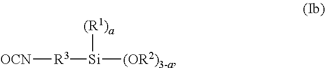

wherein R¹, R², R³ have the already mentioned meanings. Examples of suitable isocyanatosilanes of the formula (Ib) are 3-isocyanatopropyltriethoxysilane, 3-isocyanatopropyldiethoxymethylsilane, and their analogs with methoxy or isopropoxy groups in place of the ethoxy groups in the silica.

The polymer preferably has hydroxyl groups as functional end groups, which are reactive toward isocyanate groups. Suitable polymers having hydroxyl groups are, on the one hand, high molecular weight polyoxyalkylene polyols already identified, preferably polyoxypropylene diols having a degree of unsaturation of less than 0.02 meq/g and having an average molecular weight in the range from 4,000 to 30,000 g/mol, more particularly those having an average molecular weight in the range from 8,000 to 30,000 g/mol.

Also suitable on the other hand are polyurethane polymers having hydroxyl groups, especially terminated with hydroxyl groups, for reaction with isocyanatosilanes of the formula (Ib). Polyurethane polymers of this kind are obtainable through the reaction of at least one polyisocyanate with at least one polyol. This reaction may be accomplished by bringing the polyol and the polyisocyanate to reaction by customary processes, at temperatures of 50° C. to 100° C., for example, optionally with accompanying use of suitable catalysts, the polyol being metered such that its hydroxyl groups are in a stoichiometric excess in relation to the isocyanate groups of the polyisocyanate. Preferred is a ratio of hydroxyl groups to isocyanate groups of 1.3:1 to 4:1, more particularly of 1.8:1 to 3:1. The polyurethane polymer may optionally be prepared with accompanying use of plasticizers, in which case the plasticizers used contain no groups reactive toward isocyanates. Suitable for this reaction are the same polyols and polyisocyanates already referenced as being suitable for the preparation of a polyurethane polymer containing isocyanate groups that is used for preparing a silane-terminated polyurethane polymer P1.

Suitable methoxysilane-terminated polymers are commercially available, for example, under the trade names SPUR+® 1010LM, 1015LM, and 1050MM from Momentive Performance Materials Inc., USA, and also under the trade names Geniosil® STP-E15, STP-10, and STP-E35 from Wacker Chemie AG, Germany, and also under the trade name lncorez STP from Sika lncorez, UK. Preferably, the silane-terminated polymer P2 is an ethoxysilane-terminated polyurethane polymer.

According to one or more embodiments, the silane-terminated polymer is a silane-terminated polymer P3, which is obtainable by a hydrosilylation reaction of polymers, having terminal double bonds, examples being poly(meth)acrylate polymers or polyether polymers, more particularly of allyl-terminated polyoxyalkylene polymers, as described for example in U.S. Pat. Nos. 3,971,751 and 6,207,766.

Suitable methoxysilane-terminated polymers are commercially available, for example, under the trade names MS-Polymer® S203(H), S303(H), S227, S810, MA903, and S943, Silyl° SAX220, SAX350, SAX400, and SAX725, Silyl° SAT350, and SAT400, and also XMAP° SA100S, and SA310S from Kaneka Corp., Japan, and also under the trade names Excestar° S2410, S2420, S3430, S3630, W2450, and MSX931 from Asahi Glass Co, Ltd., Japan. Preferably, the silane-terminated polymer P3 is an ethoxysilane-terminated polymer.

It is also possible to use as the silane-terminated polymers other silane-terminated polymers that are commercially available, for example, under the trade name Tegopac® from Evonik Industries, more particularly Tegopac® Seal 100, Tegopac® Bond 150, Tegopac® Bond 250.

Preferably, the silane-terminated polymer is free of methoxysilane-groups, i.e. the composition preferably comprises no constituents which give off methanol upon curing in the presence of water.

The composition may further comprise at least one silane selected from the group consisting of aminosilanes, epoxysilanes, mercaptosilanes, (meth)acrylosilanes , urea silanes, and anhydridosilanes or adducts of the aforesaid silanes with primary aminosilanes. Preferably, the compositions further comprises at least one silane selected from the group consisting of aminosilanes, epoxysilanes, mercaptosilanes, and (meth)acrylosilanes. Presence of such silanes has been found to improve the mechanical properties of the cured composition.

Preferably, the total amount of said silanes, if present in the composition, is 0.05-5.0% by weight, more preferably 0.1-3.5% by weight, most preferably 0.5-2.5% by weight, based on the total weight of the composition.

The composition may further comprise at least one catalyst for the crosslinking of silane-terminated polymers, said catalyst selected from the group consisting of organotitanate, organozirconate, organostannate and organoaluminate. These catalysts contain, in particular, alkoxy groups, sulfonate groups, carboxyl groups, dialkylphosphate groups, dialkylpyrophosphate and dialkyldiketonate groups.

Particularly suitable organotitanates are the following:
titanium(IV) complex compounds having two 1,3-diketonate ligands, especially 2,4-pentanedionate (i.e., acetylacetonate), and two alkoxide ligands;
titanium(IV) complex compounds having two 1,3-ketoesterate ligands, more particularly ethyl acetoacetate, and two alkoxide ligands;
titanium(IV) complex compounds having one or more amino alkoxide ligands, more particularly triethanolamine or 2-((2-aminoethyl)amino)ethanol, and one or more alkoxide ligands;
titanium(IV) complex compounds having four alkoxide ligands;
and also organotitanates with higher degrees of condensation, especially oligomeric titanium(IV) tetrabutoxide, also referred to as polybutyl titanate.

Especially suitable as alkoxide ligands are isobutoxy, n-butoxy, isopropoxy, ethoxy, and 2-ethylhexoxy. Especially suitable are bis(ethylacetoacetato)diisobutoxytitanium(IV), bis(ethylacetoacetato)diisopropoxytitanium(IV), bis(acetylacetonato)-diisopropoxytitanium(IV), bis(acetylacetonato)diisobutoxytitanium(IV), tris(oxyethyl)amineisopropoxytitanium(IV), bis[tris(oxyethyl)amine]diisopropoxytitanium(IV), bis(2-ethylhexane-1,3-dioxy)titanium(IV), tris[2-((2-aminoethyl)amino)ethoxy]ethoxytitanium(IV), bis(neopentyl(diallyl)oxydiethoxytitanium(IV), titanium(IV) tetrabutoxide, tetra-(2-ethylhexyloxy)titanate, tetra(isopropoxy)titanate, and polybutyl titanate.

Especially suitable are the commercially available types Tyzor® AA, GBA, GBO, AA-75, AA-65, AA-105, DC, BEAT, BTP, TE, TnBT, KTM, TOT, TPT or IBAY (all from Du Pont/Dorf Ketal); Tytan PBT, TET, X85, TAA, ET, S2, S4 or S6 (all from TensoChema), and Ken-React® KR® TTS, 7, 9QS, 12, 26S, 33DS, 38S, 39DS, 44, 134S, 138S, 133DS, 158FS or LICA® 44 (all from Kenrich Petrochemicals).

Particularly suitable organozirconates are the commercially available types Ken-React® NZ® 38J, KZ® TPPJ, KZ® TPP, NZ® 01, 09, 12, 38, 44 or 97 (all from Kenrich Petrochemicals) and Snapcure® 3020, 3030, 1020 (all from Johnson Matthey & Brandenberger). A particularly suitable organoaluminate is the commercially available type K-Kat 5218 (from King Industries).

Preferably, the at least one catalyst is present in the composition in a total amount of 0.01-5.0% by weight, more preferably 0.05-2.5% by weight, even more preferably 0.075-1.5% by weight, most preferably 0.1-1.0% by weight, based on the total weight of the composition

Preferably, the composition further comprises at least one filler. The filler may be selected to improve the stone-chipping and corrosion resistance of the protective coating as well as the rheological properties of the composition

Suitable fillers are inorganic or organic fillers, examples being natural, ground or precipitated calcium carbonates, optionally with a coating of fatty acids, more particularly steric acid or siloxanes; barium sulfate (BaSO4, also called barytes or heavy spar); calcium kaolins; aluminum oxides; aluminum hydroxides; silicas, in particular finely divided silicas from pyrolysis operations; carbon blacks, especially industrially produced carbon black; PVC powders or hollow beads. Preferred fillers include calcium carbonates, calcium kaolins, carbon black, finely divided silicas, and also flame-retardant fillers, such as hydroxides or hydrates, more particularly hydroxides or hydrates of aluminum, preferably aluminum hydroxide. It is entirely possible, and may even be an advantage, to use a mixture of different fillers.

Preferably, the at least one filler is present in the composition in a total amount of 5-65% by weight , more preferably 10-60% by weight, even more preferably 20-55% by weight, most preferably 30-55% by weight, based on the total weight of the composition.

Preferably, the median particle size d₅₀ of the filler is not more than 100 μm, more preferably not more than 50 μm, most preferably not more than 25 μm. In particular, the median particle size d₅₀ of the filler can be in the range of 0.5-100.0 μm, preferably 0.5-50.0 μm, more preferably 1.0-25.0 μm, most preferably 1.0-10.0 μm.

The term median particle size d₅₀ refers in this document to a particle size below which 50% of all particles by volume are smaller than the d₅₀ value. The term “particle size” refers in this document to the area-equivalent spherical diameter of a particle. The particle size distribution can be measured by laser diffraction according to the method as described in standard ISO 13320:2009. A Mastersizer 2000 device (trademark of Malvern Instruments Ltd, GB) can be used in measuring particle size distribution.

The composition preferably comprises at least one pigment. Preferred pigments are titanium dioxide, iron oxides and carbon black. The pigment defines the color of the protective coating, helps to develop strength and can improve durability, particularly UV-stability.

Besides the ingredients already mentioned, the composition can comprise further constituents, for example,
plasticizers such as esters of organic carboxylic acids or their anhydrides, such as phthalates, for example dioctyl phthalate, diisononyl phthalate or diisodecyl phthalate, or hydrogenated phthalates, for example Hexamoll DINCH, adipates, for example dioctyl adipate, sulfonates, for example Mesamoll (Lanxess), azelates and sebacates, polyols, for example polyoxyalkylene polyols or polyester polyols, organic phosphoric and sulfonic esters, or polybutenes;
solvents;
fibers, for example of polyethylene;
dyes;
rheological modifiers such as thickeners or thixotropic agents, examples being urea compounds of the kind described as thixotropic agents (“thixotropy endowning agent”) in WO 02/48228 A2 on pages 9 to 11, and polyamide waxes;
crosslinkers, examples being silane-functional oligomers and polymers;
drying agents, for example tetraethoxysilane, vinyltriethoxysilane, α-functional silanes such as N-(silylmethyl)-O-methylcarbamates, more particularly N-(methyldiethoxysilylmethyl)-O-methylcarbamate, (methacryloyloxymethyl)silanes, ethoxymethylsilanes, N-phenyl-, N-cyclohexyl-, and N-alkylsilanes, orthoamic esters, calcium oxide, or molecular sieves;
stabilizers to counter heat, light and UV radiation;
flame retardants;
surface-active substances such as wetting agents, flow control agents, deaerating agents or defoamers;
biocides such as algicides, fungicides or fungal growth inhibitor substances;
other substances commonly used in moisture-curing compositions.

Preferably, the composition is substantially phthalate-free or phthalate-free. More particularly, the composition preferably contains no phthalate plasticizers. Preferred plasticizers are, for example, hydrogenated phthalates.

Preferably, the composition comprises less than 10% by weight, preferably less than 5% by weight, most preferably less than 1% by weight, based on the total weight of the composition, of volatile organic compounds having a boiling point of less than 300° C.

When using such further ingredients it is advantageous to ensure that they do not strongly impair the storage stability of the composition, i.e. do not massively trigger reactions leading to crosslinking of the silane-terminated polymers during storage.

The moisture-curing composition may be prepared by mixing all ingredients under exclusion of moisture to obtain a homogeneous paste. Any conventional mixing technique may be used. The composition may be stored in a suitable moisture-tight container, particularly a bucket, a drum, a hobbock, a bag, a sausage, a cartridge, a can or a bottle.

Another subject of the present invention is a method for protecting a substrate against stone-chipping and/or corrosion, the method comprising steps of:

i) Applying a composition of the present invention to at least part of a surface of the substrate to form a wet coating of the composition thereon,

ii) Allowing the water contained in said wet coating to evaporate until the film on the surface of the substrate has dried to form a protective coating to at least part of the surface of the substrate.

The composition of the invention may be applied to substrates using conventional methods known to those skilled in the art, such as by brushing, spraying, spin coating, roll coating, curtain coating, dipping, gravure coating, and/or the like. It may be desirable to clean the substrate to remove grease, dirt, and other contaminants before the application of the composition. Pre-existing coatings may or may not be removed as well, depending upon the application context. After the pre-treatment, the composition is applied to at least portion of the substrate and allowed to dry to form a protective coating on the surface of the substrate. One or more additional layers of coating can be applied if necessary to obtain a satisfactory protection. However, usually a single layer of coating is sufficient.

Suitable materials of the substrate can include metals, such as anodized aluminum and stainless steel, metal alloys, intermetallic compositions, metal-containing composites, concrete, glass, polymethyl methacrylate (PMMA), polycarbonate, PVC, ABS, wood, combinations of these, and the like. The substrate may be bare or may be at least partially coated with another coating system, such as a primer composition.

The water contained in said wet coating can be allowed to evaporate by subjecting the wet coating to air-drying at low temperature such as ambient temperature or at an elevated temperature.

The composition of the present invention is especially suitable for forming protective coatings on motor vehicles or parts of motor vehicles, in particular in the underbody protection area or in the wheel arches. The protective coating shows excellent adhesion to both primed and unprimed surfaces, in particular to metal surfaces. The composition of the present invention is particularly suitable for forming protective underbody coatings without the need for an intermediate protective layer or primer layer on the metal surface.

The composition of the present invention can be applied to the surface of a substrate at a variety of coating thicknesses. Preferably, the thickness of the coating after evaporation of the water, i.e. thickness of the protective coating, is 0.1-5.0 mm, more preferably 0.25-3.5 mm, most preferably 0.5-2.5 mm.

Another subject of the present invention is a method for sealing a joint between two substrates and/or coating a surface of a substrate, the method comprising steps of:

i) Applying a composition according to the present invention into the joint between the two substrates to form a wet sealant and/or onto the surface of the substrate to form a wet coating of the composition,

ii) Allowing the water contained in the wet sealant in the joint and/or in the wet coating on the substrate to evaporate until the sealant in the joint and/or the coating on the surface of the substrate has been dried.

Still another subject of the present invention is a method for adhesively bonding two substrates, the method comprising steps of:

i) Applying a composition of the present invention to a surface of a first substrate or to a surface of a first substrate and to a surface of a second substrate to form wet film(s) of the composition,

ii) Exposing the wet film(s) of the composition to air,

iii) Contacting the film of the composition on the surface of the first substrate with the surface of second substrate or contacting the film of the composition on the surface of the first substrate with the film of the composition on the surface of the second substrate to effect bonding between the substrates.

Still another subject of the present invention is use of the composition of the present invention for protective coating of substrates against stone-chipping and/or corrosion and/or for sealing a joint between two substrates and/or for coating a surface of a substrate and/or for adhesively bonding of two substrates.

Still another subject of the present invention is use of silane-terminated polymers, in particular silane-terminated polyurethane polymers, in sealants, coatings, and adhesives containing aqueous dispersion of water-dispersible polymers, in particular aqueous dispersions containing at least one acrylic polymer, for improving the mechanical properties of the sealants, coatings, and adhesives.

Preferably, the aqueous dispersion comprises at least 5% by weight, more preferably at least 10% by weight, even more preferably at least 15% by weight, most preferably at least 20% by weight of at least one water-dispersible polymer, preferably at least one water-dispersible acrylic polymer. Suitable acrylic polymers and silane-terminated polymers have been described above in the context of the composition of the present invention.

According to one or more embodiments, the silane-terminated polymers are used for improving the elongation at break measured according to DIN 23504 and or elastic recovery measured according to DIN 53515, of the sealants, coatings, and adhesives containing aqueous dispersions of water-dispersible polymers.

### EXAMPLE 1

Preparation of the Sealant Compositions

For each sealant composition the ingredients given in Table 2 were mixed in a sealed polypropylene beaker by means of a centrifugal mixer (SpeedMixer® DAC 150, FlakTek Inc.) until a homogenous paste was obtained. The sealant compositions were stored in tightly sealed, moisture proof cans, for 3 days before they were used for characterization of their properties.

The “acrylic sealant” used in the example compositions contained:

35% by weight of aqueous acrylate-vinyl acetate copolymer dispersion Acronal® V275 having a solids content of ca. 65%,

12% by weight of a DINP plasticizer,

48.8% by weight of calcium carbonate filler,

2% by weight of TiO₂ pigment,

2.2% by weight of additives such as dispersants and thixotropic agents.

The “moisture curing sealant” used in the example compositions contained:

20-50% by weight of silane-modified prepolymers,

30-40% by weight of commercially available calcium carbonate filler,

20-30% by weight of commercially available plasticizer,

0.1-2.5% by weight of a commercially available aminosilane, and

0.1-10% by weight of commercially available additives such as catalyst, stabilizers, thickeners, and pigments.

The sealant compositions Ex-1 to Ex-5 are compositions according to the invention and the compositions Ref-1 to Ref-3 are comparative examples.

Shelf Life

The shelf life of the sealant compositions was investigated by determining whether the compositions showed any significant changes in the viscosity and whether there was any signs curing of the silane-terminated polymers during a specific time period. During the measurement, the compositions were stored at normal room temperature for a time period of two days, six weeks, and three months, respectively.

Shore A

The Shore A hardness was determined according to DIN 53505 on sealant samples with a layer thickness of 6 mm, cured for 7 days, 14 days, and 28 days at 23° C. (RT) and 50% relative humidity, or for 7 days at 40° C.

Furthermore, several samples were measured after curing for 7 days at 40° C., followed by immersion in water for 7 days. The water uptake (in wt.-%) was determined by a laboratory balance before and after water immersion with these samples.

Tensile Strength, Elongation at Break and Modulus of Elasticity

The tensile strength, elongation at break, and 50% modulus of elasticity were determined according to DIN 23504 (tensile speed 200 mm/min) on sealant samples having a thickness of 2 mm, cured for 14 days at 23° C. and 50% relative humidity.

Tear Propagation Resistance

The tear propagation resistance was determined according to DIN 53515 on sealant samples having a thickness of 2 mm cured for 7 days at 23° C. and 50% relative humidity.

Elastic Recovery

The elastic recovery was determined according to DIN 53515 on sealant samples having a thickness of 2 mm cured for 7 days at 23° C. and 50% relative humidity. The elastic recovery in percentage was calculated by dividing the length of the stretched test specimen after a predetermined recovery period by original non-stretched length of the of the test specimen.

Bead Adhesion

For testing the adhesion properties, the tested composition was applied in the form of a bead (ca. 150 mm long, 12 mm wide, and 6 mm high) to a substrate (plate) using a round nozzle with a diameter of approximately 10 mm. In each case, the substrate had been cleaned beforehand by wiping with a cloth soaked with Sika® Cleaner-205 and left to dry for 5 minutes. The substrate coated with the bead was then cured for 7 days at a temperature of 40° C., after which the adhesion was tested. The adhesion was also tested after curing of 7 days at a temperature of 40° C. followed by immersion in water for 7 days.

To test the adhesion, the cured bead was incised at one end just above the surface of the substrate (adhesion face). The incised end of the bead was held by hand and then carefully and slowly pulled from the substrate, with a peeling action in the direction of the other end of the bead. If in the course of this operation the adhesion was sufficiently strong that the end of the bead threatened to tear off on pulling, a cutter was used to apply a cut perpendicularly to the bead-pulling direction, down to the bare surface of the substrate, and in this way a section of bead was detached. Cuts of this kind were repeated if necessary in the course of further pulling at intervals of 2 to 3 mm. In this way the entire bead was peeled from the substrate.

The proportion of the cured sealant in percentage that remained on the substrate surface after the whole bead had been peeled off (cohesive fracture) was recorded as the representative value for the cohesive component of the adhesion face. The adhesion properties were then rated based on the measured cohesive failure values and on the criteria as presented in Table 1.

TABLE 1

| Rating | Cohesive failure | Evaluation |
|---|---|---|
| 1 | More than 95% | Sufficient |
| 2 | 75-95% | Sufficient |
| 3 | 25-75% | Insufficient |
| 4 | less than 25% | Insufficient |
| 5 | 0% | Insufficient |

TABLE 2
Sealant compositions and storage stability

| | Ref-1 | Ex 1 | Ex 2 | Ex 3 | Ex 4 | Ex 5 | Ref-2 | Ref-3 |
|---|---|---|---|---|---|---|---|---|
| Acrylic sealant [ppw.] | 100 | 100 | 100 | 100 | 100 | 100 | 100 | 0 |
| Moisture curing sealant | 0 | 1 | 2 | 5 | 10 | 15 | 22 | 100 |
| [ppw] | | | | | | | | |
| Total | 100 | 101 | 102 | 105 | 110 | 115 | 122 | 100 |
| Shelf life 2 days at RT | Ok, smooth | Ok, smooth | Ok, smooth | Ok, smooth | Ok, smooth | Ok, smooth | Not ok, | |
| | paste | paste | paste | paste | paste | paste | coarse paste, | |
| | | | | | | | cured | |
| | | | | | | | material at | |
| | | | | | | | edges | |
| Shelf life 6 weeks days | Ok, smooth | Ok, smooth | Ok, smooth | Ok, smooth | Ok, smooth | Not ok, | Not ok, | |
| at RT | paste | paste | paste | paste | paste | slightly | coarse paste, | |
| | | | | | | coarse paste, | high viscosity | |
| | | | | | | increased | | |
| | | | | | | viscosity | | |
| Shelf life 3 months at | Ok, smooth | Ok, smooth | Ok, smooth | Ok, smooth | Ok, smooth | Not ok, | Not ok, | |
| RT | paste | paste | paste | paste | paste | slightly | coarse paste, | |
| | | | | | | coarse paste, | high viscosity | |
| | | | | | | increased | | |
| | | | | | | viscosity | | |
| Skinning time [min] | 10 | 10 | 10 | 8 | 7 | 5 | 3 | 30 |

TABLE 3
Mechanical properties of sealants

| | Ref-1 | Ex 1 | Ex 2 | Ex 3 | Ex 4 | Ex 5 | Ref-2 | Ref-3 |
|---|---|---|---|---|---|---|---|---|
| Shore A 7 days at RT | 8 | 8 | 8 | 8 | 9 | 10 | 10 | 30 |
| Shore A 14 days at RT | 10 | 10 | 11 | 11 | 12 | 13 | 14 | 20 |
| Shore A 28 days at RT | 12 | 12 | 12 | 12 | 13 | 14 | 15 | 32 |
| Shore A 7 days at 40° C. | 29 | 30 | 29 | 28 | 29 | 30 | 32 | 29 |
| Tensile strength 7 days | 0.47 | 0.44 | 0.44 | 0.45 | 0.49 | 0.49 | 0.53 | 1 |
| at 40° C. [MPa] | | | | | | | | |
| Elongation at Fₘₐₓ [%] | 220 | 242 | 244 | 251 | 252 | 263 | 221 | 185 |
| Elongation at break [%] | 258 | 282 | 290 | 304 | 302 | 326 | 237 | 186 |
| 50% modulus [MPa] | 0.29 | 0.27 | 0.26 | 0.27 | 0.29 | 0.3 | 0.34 | 0.5 |
| Tear propagation | 4.4 | 4.3 | 4.2 | 4 | 4.2 | 4.4 | 4.5 | 1.9 |
| resistance [N/mm] | | | | | | | | |
| Elastic recovery [%] | | | | | | | | |
| 30 s after 1 min | 84 | 87 | 87 | 87 | 90 | 91 | 91 | 93^{a)} |
| stretching of 200% | | | | | | | | |
| 1 min after 1 min | 87 | 91 | 90 | 90 | 93 | 93 | 93 | 96^{a)} |
| stretching of 200% | | | | | | | | |
| 5 min after 1 min | 93 | 95 | 94 | 94 | 95 | 95 | 94 | 97^{a)} |
| stretching of 200% | | | | | | | | |

^{a)}Measured with 150% elongation

TABLE 4
Water resistance of sealants

| | Ref-1 | Ex 1 | Ex 2 | Ex 3 | Ex 4 | Ex 5 | Ref-2 | Ref-3 |
|---|---|---|---|---|---|---|---|---|
| Shore A 7 days at 40° C. | 29 | 30 | 29 | 28 | 29 | 30 | 32 | 29 |
| +7 days in H₂O^{a} | <5 | <5 | <5 | <5 | <5 | <5 | <5 | 24 |
| +7 days at 40° C. | 37 | 34 | 33 | 33 | 33 | 33 | 33 | 32 |
| Water uptake after 7 days | 36 | 32 | 32 | 30 | 29 | 25 | 22 | 2 |
| in H₂O [wt.-%] | | | | | | | | |
| Change in water uptake | −1.56 | −1.41 | −1.4 | −1.35 | −1.32 | −1.21 | −1.14 | 0.18 |
| after 7 days in H₂O + 7 | | | | | | | | |
| days at 40° C. [wt.-%] | | | | | | | | |

^{a)}samples stored Immersed in water

TABLE 5
Bead adhesion

| | Ref-1 | Ex 1 | Ex 2 | Ex 3 | Ex 4 | Ex 5 | Ref-2 | Ref-3 |
|---|---|---|---|---|---|---|---|---|
| Concrete after 7 days at 40° C. | 1 | 1 | 2 | 2 | 4 | 5 | 5 | 1 |
| +7 days in H₂O | 5+ | 1 | 1 | 1 | 1 | 1 | 1 | 4 |
| Porous tile after 7 days at 40° C. | 1 | 1 | 1 | 1 | 1 | 1 | 1 | 1 |
| +7 days in H₂O | 5 | 5 | 5 | 5 | 5 | 5 | 5 | 1 |
| Glazed tile after 7 days at 40° C. | 1 | 1 | 1 | 1 | 1 | 1 | 1 | 1 |
| +7 days in H₂O | 5 | 5 | 5 | 5 | 5 | 5 | 5 | 1 |
| Glass after 7 days at 40° C. | 1 | 1 | 1 | 1 | 1 | 1 | 1 | 5 |
| +7 days in H₂O | 5 | 5 | 5 | 5 | 5 | 5 | 5 | 5 |
| Anodized Aluminum after 7 days at 40° C. | 5 | 5 | 5 | 5 | 5 | 5 | 5 | 1 |
| +7 days in H₂O | 2 | 1 | 1 | 1 | 1 | 1 | 2 | 1 |
| Aluminized steel after 7 days at 40° C. | 1 | 2 | 5 | 4 | 1 | 1 | 1 | 1 |
| +7 days in H₂O | 1 | 1 | 1 | 1 | 1 | 1 | 1 | 1 |
| PMM Aafter 7 days at 40° C. | 5 | 5 | 5 | 5 | 5 | 5 | 5 | 5 |
| +7 days in H₂O | 3 | 3 | 3 | 4 | 5+ | 5+ | 5+ | 5 |
| Polycarbonate after 7 days at 40° C. | 5 | 5 | 5 | 5 | 5 | 5 | 5 | 3 |
| +7 days in H₂O | 1 | 1 | 1 | 1 | 1 | 1 | 1 | 4 |
| PVC after 7 days at 40° C. | 5 | 5 | 5 | 5 | 5 | 5 | 5 | 5 |
| +7 days in H₂O | 1 | 1 | 1 | 1 | 1 | 1 | 1 | 5+ |
| ABS after 7 days at 40° C. | 5 | 5 | 5 | 5 | 5 | 5 | 5 | 5 |
| +7 days in H₂O | 4 | 4 | 5+ | 5+ | 5+ | 5+ | 5+ | 5 |
| Wood after 7 days at 40° C. | 1 | 1 | 1 | 1 | 1 | 1 | 1 | 1 |

### EXAMPLE 2

Preparation of the Protective Coating Compositions

For each protective coating composition the ingredients given in Tables 6 and 7 were mixed in a sealed polypropylene beaker by means of a centrifugal mixer (SpeedMixer® DAC 150, FlakTek Inc.) until a homogenous paste was obtained. The coating compositions were stored in tightly sealed, moisture proof cans, for 1-7 days before they were used for testing properties of the protective coatings.

The “acrylic coating” used in the example compositions contained:

30-40% by weight of a commercially available water-based styrene-acrylic acid ester copolymer dispersion,

5-15% by weight of a commercially available epoxy resin dispersion,

35-65% by weight of fillers, such as muscovite,

5-10% of additives such as plasticizers, pigments, anti-foaming agents, deflocculating agents, and water.

The same “moisture curing sealant” was used as in Example 1.

The “STP-S” silane-terminated polyurethane polymer was prepared as follows:

1000 g polyol (Acclaim® 12200, low monol polyoxypropylene diol from Covestro; OH-number 11.0 mg KOH/g; water content ca. 0.02 wt.-%), 35.2 g isophorone diisocyanate (Vestanat® IPDI from Evonik Industries), 122.5 g diisodecyl phthalate, and 0.12 g dibutyltin dilaurate were heated under exclusion of moisture and with continuous stirring to a temperature of 90° C. and kept at this temperature until a the content of free isocyanate groups, determined by titrimetry, reached a value of 0.39 wt.-%. Subsequently, 36.9 g N-(3-trimethoxysilylpropyl)aminosuccinic acid diethyl ester were added and the stirring was continued until no free isocyanate groups were detected by FT-IR spectroscopy. The produced silane-terminated polymer was cooled to room temperature and stored under the exclusion of moisture.

The protective coating compositions Ex-6 to Ex-23 are compositions according to the invention and the compositions Ref-4 and Ref-5 are comparative examples.

Stone-Chip Resistance

The stone-chip resistance of the coating samples were determined by following the procedure as described in GMW 15487 standard.

For the measuring of the stone-chip resistances, metallic sheets having dimensions of 10 cm×20 cm×1 mm were coated with the tested compositions with a coating thickness of 500-1000 μm. The coated sheets were then dried for three days at a temperature of 50° and for 24 hours at normal room temperature (23° C., ca. 50% relative humidity).

In the stone chip resistance test, the metal sheets coated with the protective coatings were bombarded with square edged iron chips having a particle size of 4.00-5.00 mm (Hartguss GH Diamant, from Eisenwerk Würth) at normal room temperature (23° C., ca. 50% relative humidity). The iron chips were accelerated to a speed of approximately 10 m/s before being impacted to the surface of the metal plate.

The measurement was continued until a first hole penetrating through the full thickness of the coating was observed by visual means. The time period from the beginning of the measurement until the end of bombarding was recorded as the stone-chip resistance time.

The values of stone-chip resistance times presented in Tables 6 and 7 represent have been calculated as an average of two measurements conducted using the same protective coating.

TABLE 6
Stone-chip resistance of coatings

| | Ref-4 | Ex 6 | Ex 7 | Ex 8 | Ex 9 | Ex 10 | Ex 11 | Ex 12 | Ex 13 |
|---|---|---|---|---|---|---|---|---|---|
| Acrylic coating [wt.-%] | 100 | 90 | 90 | 90 | 95 | 95 | 95 | 95 | 95 |
| Moisture curing sealant [wt.-%] | 0 | 10 | | | 5 | | | | |
| Desmoseal S XP 2636^{a} [wt.-%] | | | 10 | | | 5 | | | |
| Desmoseal S XP 2774^{b} [wt.-%] | | | | 10 | | | 5 | | |
| STP-E 35^{c} [wt.-%] | | | | | | | | 5 | |
| STP S^{d} [Wt.-%] | | | | | | | | | 5 |
| Total | 100 | 100 | 100 | 100 | 100 | 100 | 100 | 100 | 100 |
| Coating thickness [μm] | 1000 | 1000 | 1000 | 1000 | 1000 | 1000 | 1000 | 1000 | 1000 |
| Resistance [seconds] | 290 | 800 | 1700 | 1690 | 930 | 890 | 1110 | 950 | 925 |

^{a}Silane-terminated polyurethane polymer (from Covestro)
^{b}Silane-terminated polyurethane polymer (from Covestro)
^{c}Trimethoxysilylpropylcarbamate-terminated polyether (from Wacker Chemie AG)
^{d}Silane-terminated polyurethane polymer

TABLE 7
Stone-chip resistance of coatings

| | Ref-5 | Ex 14 | Ex 15 | Ex 16 | Ex 17 | Ex 18 | Ref-6 | Ex 19 | Ex 20 | Ex 21 | Ex 22 | Ex 23 |
|---|---|---|---|---|---|---|---|---|---|---|---|---|
| Acrylic coating [wt.-%] | 100 | 95 | 95 | 95 | 95 | 95 | 100 | 95 | 95 | 95 | 95 | 95 |
| Moisture curing sealant | 0 | 5 | | | | | 0 | 5 | | | | |
| [wt.-%] | | | | | | | | | | | | |
| Desmoseal S XP 2636^{a} | | | 5 | | | | | | 5 | | | |
| [wt.-%] | | | | | | | | | | | | |
| Desmoseal S XP 2774^{b} | | | | 5 | | | | | | 5 | | |
| [wt.-%] | | | | | | | | | | | | |
| STP-E 35^{c} [wt.-%] | | | | | 5 | | | | | | 5 | |
| STP-S^{d} [wt.-%] | | | | | | 5 | | | | | | 5 |
| Total | 100 | 100 | 100 | 100 | 100 | 100 | 100 | 100 | 100 | 100 | 100 | 100 |
| Coating thickness [μm] | 750 | 750 | 750 | 750 | 750 | 750 | 500 | 500 | 500 | 500 | 500 | 500 |
| Resistance [seconds] | 400 | 1000 | 1750 | 1220 | 1190 | 1175 | 400 | 600 | 625 | 800 | 575 | 775 |

^{a}Silane-terminated polyurethane polymer (from Covestro)
^{b}Silane-terminated polyurethane polymer (from Covestro)
^{c}Trimethoxysilylpropylcarbamate-terminated polyether (from Wacker Chemie AG)
^{d}Silane-terminated polyurethane polymer

1. A composition comprising:
a) an aqueous polymer dispersion of at least one water-dispersible polymer,
b) at least one silane-terminated polymer, and
c) optionally at least one catalyst for the crosslinking of said silane-terminated polymers, wherein the at least one silane-terminated polymer has at least one terminal group of formula (I): 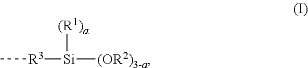
wherein
R¹ is an alkyl-group having 1 to 8 C atoms,
R² is an acyl or alkyl group having 1 to 5 C atoms,
R³ is a linear or branched, or cyclic, alkylene group having 1 to 12 C atoms, optionally with aromatic moieties, and optionally with 1 or more heteroatoms, and
a is 0 or 1 or 2.

2. The composition according to claim 1, wherein the at least one water-dispersible polymer is present in a total amount of 1-50% by weight, based on the total weight of the composition.

3. The composition according to claim 1 containing 1.0-35.0% by weight of water, based on the total weight of the composition.

4. The composition according to claim 1, wherein the at least one water-dispersible polymer is selected from the group consisting of styrene-(meth)acrylate copolymers; styrene-butadiene copolymers; (meth)acrylate-vinyl acetate copolymers; copolymers of (meth)acrylates and vinyl esters of tertiary carboxylic acids; copolymers of (meth)acrylates, vinyl esters of tertiary carboxylic acids, and vinyl acetate; ethylene-acrylic acid copolymer; poly(meth)acrylates; ethylene-vinyl acetate copolymers; copolymers of vinyl acetate, ethylene, and vinyl ester; and polyurethanes.

5. The composition according to claim 1, wherein the aqueous polymer dispersion comprises at least one water-dispersible polymer having a glass transition temperature (T_{g}) measured by differential scanning calorimetry (DSC) according to ISO 11357 standard using a heating rate of 2° C./min of 5-100° C.

6. The composition according to claim 1 wherein the aqueous polymer dispersion comprises at least one water-dispersible polymer having a glass transition temperature T_{g} measured by differential scanning calorimetry (DSC) according to ISO 11357 standard using a heating rate of 2° C./min of <50° C.

7. The composition according to claim 1, wherein the at least one silane-terminated polymer is a silane-terminated polyurethane polymer.

8. The composition according to claim 1, further comprising at least one silane selected from aminosilanes, epoxysilanes, mercaptosilanes, and (meth)acrylic silanes.

9. The composition according to claim 1, comprising at least one filler, which is present in the composition in a total amount of 5-65% by weight, based on the total weight of the composition.

10. A method for producing a composition according to claim 1 comprising steps of providing in a mixer the ingredients as defined in claim 1 and mixing these until a homogeneous paste is obtained.

11. A method for protecting a substrate against stone-chipping and/or corrosion, the method comprising steps of:
i) applying a composition according to claim 1 to at least part of a surface of the substrate to form a wet coating thereon,
ii) allowing the water contained in the wet coating of the composition to evaporate until the film on the surface of the substrate has dried to form a protective coating to at least part of the surface of the substrate.

12. The method according to claim 11, wherein the thickness of the protective coating is 0.1-5.0 mm.

13. A method for sealing a joint between two substrates and/or coating a surface of a substrate, the method comprising steps of:
i) applying a composition according to claim 1 into the joint between the two substrates to form a wet sealant and/or onto the surface of the substrate to form a wet coating of the composition,
ii) allowing the water contained in the wet sealant in the joint and/or in the wet coating on the substrate to evaporate until the sealant in the joint and/or the coating on the surface of the substrate has dried.

14. A method for adhesively bonding two substrates, the method comprising steps of:
i) applying a composition according to claim 1 to a surface of a first substrate or to a surface of a first substrate and to a surface of a second substrate to form wet film(s) of the composition,
ii) exposing the wet film(s) of the composition to air,
iii) contacting the film of the composition on the surface of the first substrate with the surface of second substrate or contacting the film of the composition on the surface of the first substrate with the film of the composition on the surface of the second substrate to effect bonding between the substrates.

15. A method of using a protective coating of substrates against stone-chipping and/or corrosion and/or for sealing a joint between two substrates and/or for coating a surface of a substrate and/or for adhesively bonding of two substrates, the coating based on the composition of claim 1.

16. A method of improving the mechanical properties of sealants, coatings, and adhesives, the method using silane-terminated polymers in sealants, coatings, and adhesives containing aqueous dispersion of water-dispersible polymers.
